(19) United States
(12) Patent Application Publication
(10) Pub. No.: US 2013/0037350 A1
(43) Pub. Date: Feb. 14, 2013

(54) LIGHTWEIGHT LADDER

(71) Applicants: GROVER J. GEISELMAN, III, Richmond, TX (US); Jesse McDade, Houston, TX (US)

(72) Inventors: GROVER J. GEISELMAN, III, Richmond, TX (US); Jesse McDade, Houston, TX (US)

(21) Appl. No.: 13/652,429

(22) Filed: Oct. 15, 2012

Related U.S. Application Data
(63) Continuation-in-part of application No. 13/191,339, filed on Jul. 26, 2011.

(51) Int. Cl. E06C 1/383; E06C 7/00; E06C 7/14; E06C 7/46

(52) U.S. Cl. 182/108; 182/159; 182/129

(57) ABSTRACT

A foldable ladder moveable between a folded position and an unfolded position, wherein the ladder can have a two support members, each with an inner surface. Grooves can be disposed in each inner surface. When the foldable ladder is in the folded position, a portion of each groove of one of the support members can be aligned with a portion of at least one of the grooves of the other support member. The ladder can have a rungs secured in the grooves to secure the support members together. Each rung can be pivotable to move the ladder between the folded position and the unfolded position. When the ladder is in the unfolded position, the rungs can extend perpendicular to the support members. When the ladder is in the folded position, each rung can rest within two of the grooves; thereby allowing the support members to engage together.

This application is a continuation-in-part of U.S. application Ser. No. 13/191,339 filed on Jul. 26, 2011.

### FIELD

The present embodiments generally relate to a lightweight foldable ladder.

### BACKGROUND

A need exists for a foldable ladder that is lightweight and small.

A need exists for a ladder that can be folded for transport and storage in small spaces, such as for transport in a small vehicle or storage in a closet.

A need exists for a foldable ladder that can be unfolded quickly and easily for use.

The present embodiments meet these needs.

### BRIEF DESCRIPTION OF THE DRAWINGS

The detailed description will be better understood in conjunction with the accompanying drawings as follows:

FIG. 1 depicts an exploded view of the foldable ladder according to one or more embodiments.

FIG. 2A depicts a detailed view of a first support member according to one or more embodiments.

FIG. 2B depicts a detailed view of a second support member according to one or more embodiments.

FIG. 3 depicts an assembled view of the foldable ladder in an unfolded configuration according to one or more embodiments.

FIG. 4A depicts an assembled view of the foldable ladder in a folded configuration according to one or more embodiments.

FIG. 4B depicts a detailed view of a portion of the foldable ladder of FIG. 4A.

FIG. 5 shows a side view of the foldable ladder according to one or more embodiments.

FIG. 6A depicts an exploded view of the foldable ladder according to one or more embodiments.

FIG. 6B depicts a detailed view of a portion of the foldable ladder of FIG. 6A according to one or more embodiments.

FIG. 6C depicts a detailed view of a portion of the foldable ladder of FIG. 6A according to one or more embodiments.

FIG. 6D depicts a side view of the foldable ladder of FIG. 6A according to one or more embodiments.

FIG. 7A depicts a front view of a foldable ladder in an extended and straightened position according to one or more embodiments.

FIG. 7B depicts a front view of a foldable ladder in an extended and bent over double position according to one or more embodiments.

FIG. 7C depicts a side view of a foldable ladder in an extended and bent over double position according to one or more embodiments.

FIG. 7D depicts a front view of a foldable ladder in a folded and bent over double position according to one or more embodiments.

FIG. 8A depicts a foldable ladder in an extended position according to one or more embodiments.

FIG. 8B depicts a foldable ladder in a folded position according to one or more embodiments.

FIG. 9A depicts a foldable ladder in an extended position according to one or more embodiments.

FIG. 9B depicts a foldable ladder in a folded position according to one or more embodiments.

FIG. 10A depicts an exploded view of a foldable ladder with foot lever actuated locking bars in the locked extended position according to one or more embodiments.

FIG. 10B depicts an exploded view of a foldable ladder with foot lever actuated locking bars in the unlocked position according to one or more embodiments.

FIG. 11A depicts a view of a foldable ladder with foot lever actuated locking bar in the locked extended position according to one or more embodiments.

FIG. 11B depicts a view of a foldable ladder in the folded position with a foot lever actuated locking bar in the unlocked position according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a lightweight foldable ladder. The foldable ladder can be moveable between a folded position and an unfolded position, allowing the foldable ladder to be folded for transport and storage in small spaces, such as for transport in small vehicles or storage in closets. The foldable ladder can be secured in the folded position by magnets, and can be quickly unfolded for use by disengaging the magnets.

The foldable ladder can have a first support member with a first inner surface, and a second support member with a second inner surface. A first plurality of grooves can be disposed in the first inner surface, and a second plurality of grooves can be disposed in the second inner surface.

In operation, when the foldable ladder is in the folded position, a portion of each groove of the first plurality of grooves can be aligned with a portion of at least one of the grooves of the second plurality of grooves; thereby allowing a rung to connect between the grooves to secure the first support member to the second support member.

The foldable ladder can have a plurality of rungs, and each rung can be secured at a first end within one of the first plurality of grooves and at a second end within one of the second plurality of grooves. Each rung can be pivotable to move the foldable ladder between the folded position and the unfolded position.

In operation, when the foldable ladder is in the unfolded position, the plurality of rungs can extend perpendicular to the first support member and the second support member. Also, when the foldable ladder is in the folded position, each rung can rest at least partially within one of the first plurality of grooves and within one of the second plurality of grooves; thereby allowing the first support member to engage the second support member.

The foldable ladder can have a first plurality of magnets disposed on the first support member, and a second plurality of magnets disposed on the second support member. Each of the first plurality of magnets can form a magnet pair with one of the second plurality of magnets. In one or more embodiments, the foldable ladder can have a first magnet disposed on the first support member and a second magnet disposed on the second support member. The first magnet and the second magnet can form a first magnet pair. In operation, when the foldable ladder is in the unfolded position, each magnet pair can be in a disengaged configuration, such that the magnets of the magnet pair are not magnetically or physically engaged. Also in operation, when the foldable ladder is in the folded position, the magnets of each magnet pair can be in a magnetically engaged configuration to secure the first support member to the second support member.

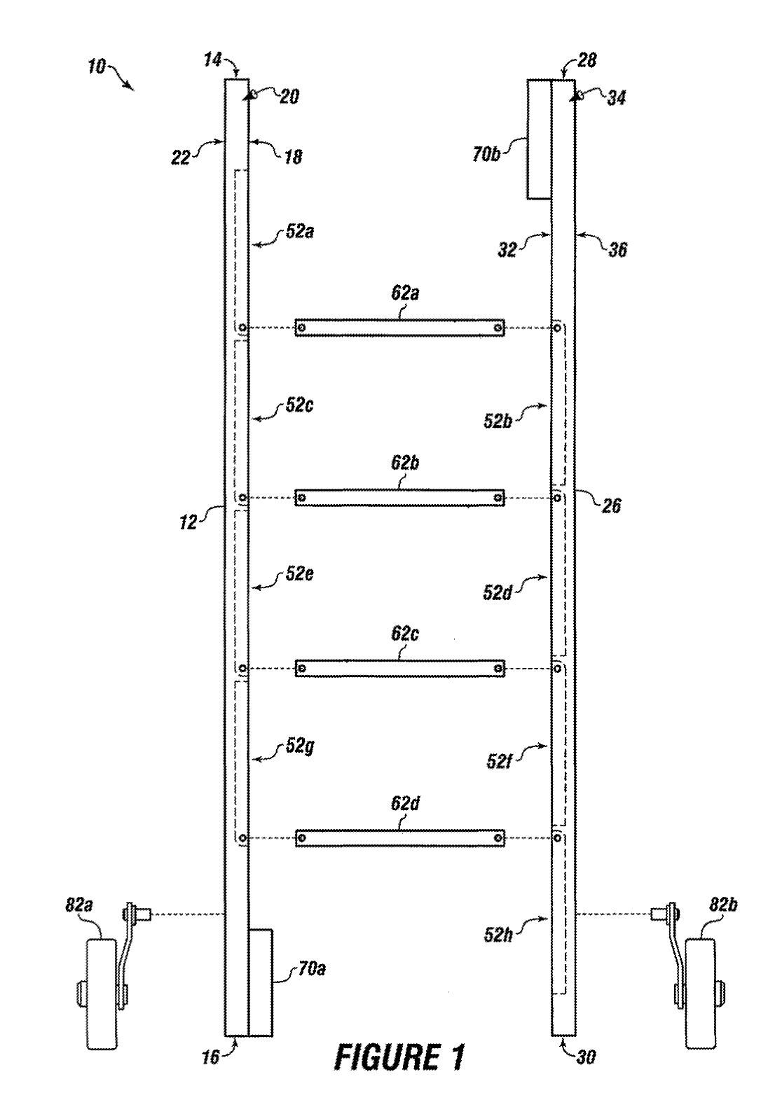

Turning now to the Figures, FIG. 1 depicts an exploded view of a foldable ladder according to one or more embodiments. The foldable ladder 10 can be a lightweight foldable ladder, and can be made of a metal, such as aluminum. The foldable ladder 10 can also be made of a composite polymer, a metal alloy, or a polymer coated metal.

The foldable ladder 10 can have a first support member 12 with a first top rounded end 14, a first bottom rounded end 16, a first front surface 20, a first inner surface 18, and a first outer surface 22. The foldable ladder 10 can have a second support member 26 with a second top rounded end 28, a second bottom rounded end 30, a second front surface 34, a second inner surface 32, and a second outer surface 36.

The first support member 12 can have a first plurality of grooves 52a, 52c, 52e and 52g disposed in the first inner surface 18. The second support member 26 can have a second plurality of grooves 52b, 52d, 52f and 52h disposed in the second inner surface 32.

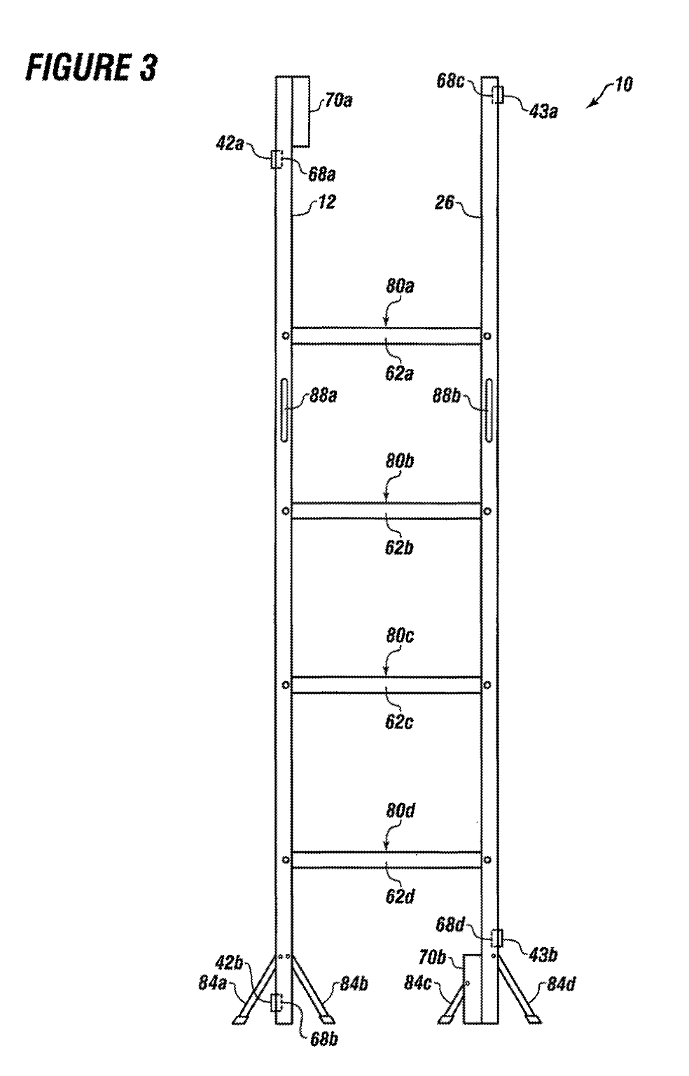

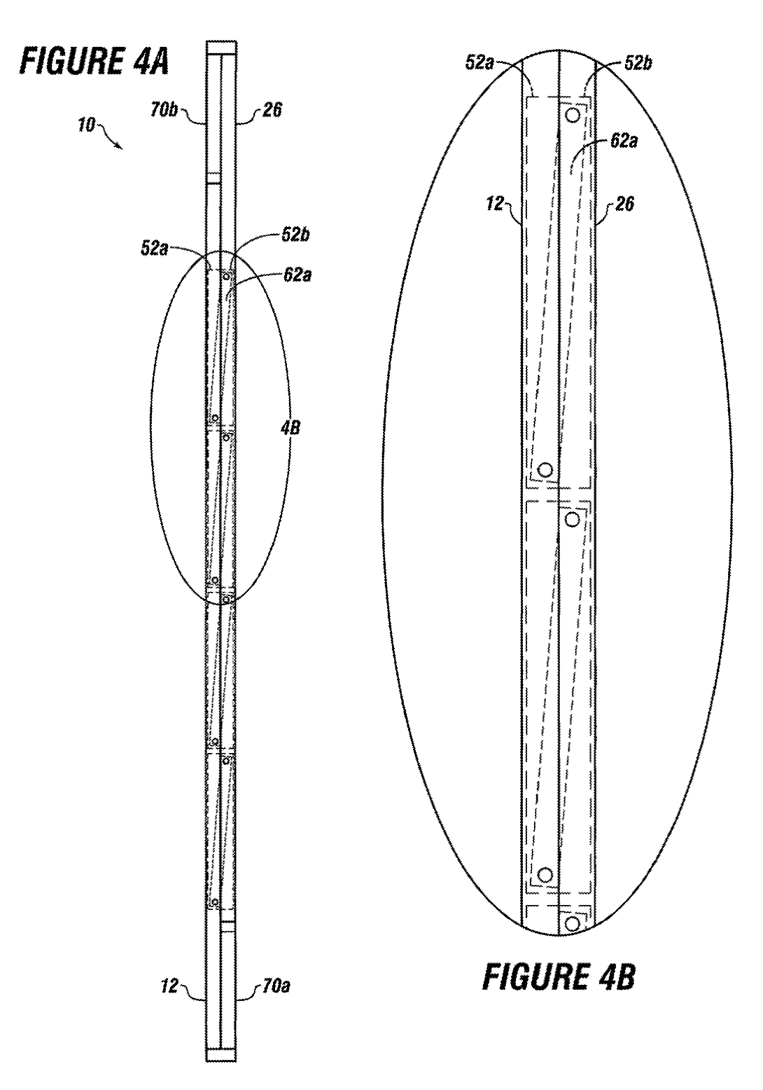

The foldable ladder 10 can have a plurality of rungs 62a, 62b, 62c and 62d. Each rung 62a, 62b, 62c and 62d can be secured at a first end within one of the first plurality of grooves 52a, 52c, 52e and 52g. Also, each rung of the plurality of rungs 62a, 62b, 62c and 62d can be secured at a second end within one of the second plurality of grooves 52b, 52d, 52f and 52h. The plurality of rungs 62a, 62b, 62c and 62d can be moveable rungs and hollow metal rungs. The plurality of rungs 62a, 62b, 62c and 62d can secure the first support member 12 to the second support member 26. Each rung of the plurality of rungs 62a, 62b, 62c and 62d can be pivotable to move the foldable ladder between the folded position, as shown in FIGS. 4A-4B and the unfolded position, as shown in FIG. 3.

In operation, when the foldable ladder is in the unfolded position, a portion of each groove of the first plurality of grooves 52a, 52c, 52e and 52g can be aligned with a portion of at least one of the grooves of the second plurality of grooves 52b, 52d, 52f and 52h. For example, a portion of the first groove 52a is shown aligned with a portion of the second groove 52b, and the first rung 62a is shown engaged within the aligned portions of the first groove 52a and the second groove 52b. A portion of the third groove 52c is shown aligned with a portion of the fourth groove 52d, and the second rung 62b is shown engaged within the aligned portions of the third groove 52c and the fourth groove 52d. A portion of the fifth groove 52e is shown aligned with a portion of the sixth groove 52f, and the third rung 62c is shown engaged within the aligned portions of the fifth groove 52e and the sixth groove 52f. A portion of the seventh groove 52g is shown aligned with a portion of the eighth groove 52h, and the fourth rung 62d is shown engaged within the aligned portions of the seventh groove 52g and the eighth groove 52h.

The foldable ladder 10 can also include a first safety extension block 70a on the first support member 12, and a second safety extension block 70b on the second support member 26.

The foldable ladder 10 can have a first wheel 82a pivotably connected proximate the first bottom rounded end 16 of the first support member 12, and a second wheel 82b pivotably connected proximate the second bottom rounded end 30 of the second support member 26. The wheels 82a and 82b can be pivotable between a transport position, as shown, and a storage position. When the wheels 82a and 82b are in the transport position, the wheels 82a and 82b can support the foldable ladder 10 for ease of transport.

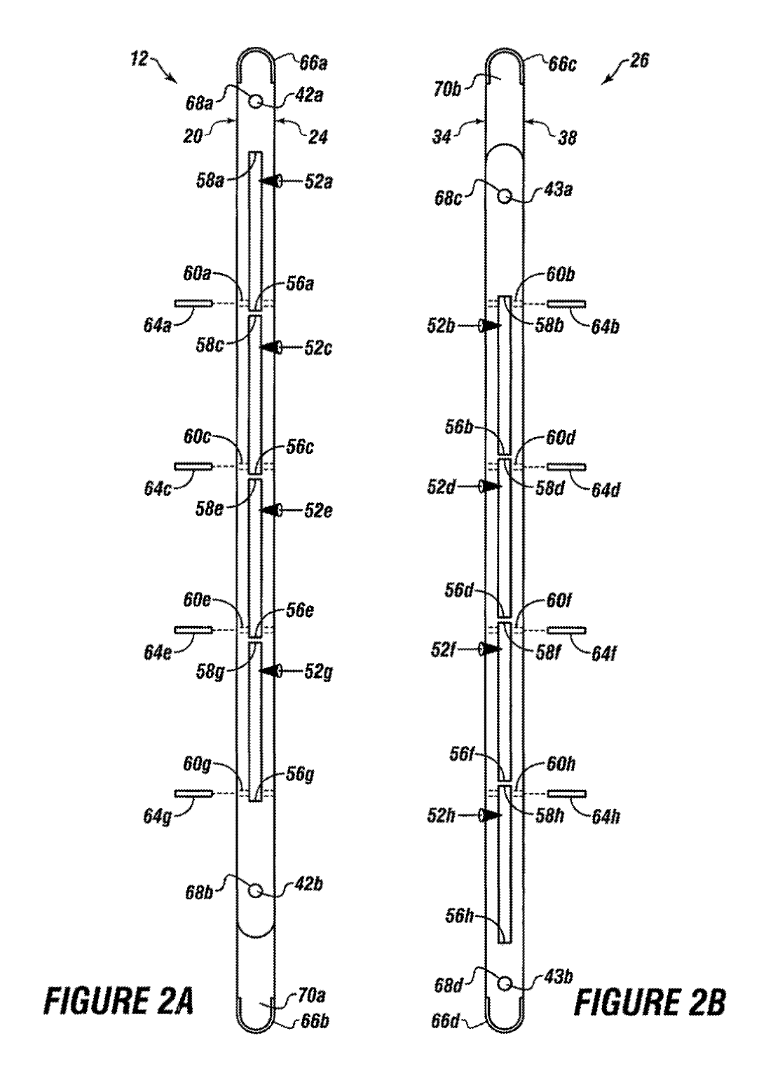

FIGS. 2A-2B depict detailed views of the first support member 12 and the second support member 26.

Each groove of the first and second plurality of grooves 52a, 52b, 52c, 52d, 52e, 52f, 52g and 52h can have a groove bottom end and a groove top end. For example, the first groove 52a can have a first groove top end 58a and a first groove bottom end 56a, the second groove 52b can have a second groove top end 58b and a second groove bottom end 56b, the third groove 52c can have a third groove top end 58c and a third groove bottom end 56c, the fourth groove 52d can have a fourth groove top end 58d and a fourth groove bottom end 56d, the fifth groove 52e can have a fifth groove top end 58e and a fifth groove bottom end 56e, the sixth groove 52f can have a sixth groove top end 58f and a sixth groove bottom end 56f, the seventh groove 52g can have a seventh groove top end 58g and a seventh groove bottom end 56g, and the eighth groove 52h can have an eighth groove top end 58h and an eighth groove bottom end 56h.

The foldable ladder 10 can have a first plurality of magnets disposed on the first support member 12, and a second plurality of magnets disposed on the second support member 26. For example, first magnets 42a and 42b can be disposed on the first support member 12, and second magnets 43a and 43b can be disposed on the second support member 26. Each of the first magnets 42a and 42b can form a magnet pair with one of the second magnets 43a and 43b. For example, the first magnet 42a can form a magnet pair with the second magnet 43a, and the first magnet 42b can form a magnet pair with the second magnet 43b. In operation, when the foldable ladder is in the unfolded position, each magnet pair can be in a disengaged configuration, such that the magnets of the magnet pair are not touching and are not magnetically engaged. Also, when the foldable ladder is in the unfolded position, each first magnet 42a and 42b and second magnet 43a and 43b that form a magnet pair can be oriented diagonally from one another. For example, the first magnet 42a can be oriented diagonally from the second magnet 43a, and the first magnet 42b can be oriented diagonally from the second magnet 43b. When the foldable ladder is in the folded position, the magnets of each magnet pair can be in a magnetically engaged configuration to secure the first support member 12 to the second support member 26.

In one or more embodiments, each first magnet 42a and 42b can be recessed into the first inner surface, and each second magnet 43a and 43b can be recessed into the second inner surface. In one or more embodiments, each first magnet 42a and 42b and second magnet 43a and 43b can be contained within one of a plurality of non-magnetic housings 68a, 68b, 68c and 68d. The plurality of non-magnetic housings 68a, 68b, 68c and 68d can be disposed in the first inner surface and the second inner surface for containing the first magnets 42a and 42b and second magnets 43a and 43b. The plurality of non-magnetic housing 68a, 68b, 68c and 68d can surround the first magnets 42a and 42b and second magnets 43a and 43b.

The first support member 12 and the second support member 26 can have a plurality of fastener holes 60a, 60b, 60c, 60d, 60e, 60f, 60g and 60h disposed through the first support member 12 and the second support member 26.

Each of the fastener holes 60a, 60c, 60e and 60g can extend from the first front surface 20 to the first back surface 24 and through one the first plurality of grooves 52a, 52c, 52e and 52g. For example, the first fastener hole 60a can extend through the first groove 52a, the third fastener hole 60c can extend through the third groove 52c, the fifth fastener hole 60e can extend through the fifth groove 52e, and the seventh fastener hole 60g can extend through the seventh groove 52g

Each of the fastener holes 60b, 60d, 60f and 60h can extend from the second front surface 34 to the second back surface 38 and through one the second plurality of grooves 52b, 52d, 52f and 52h. For example, the second fastener hole 60b can extend through the second groove 52b, the fourth fastener hole 60d can extend through the fourth groove 52d, the sixth fastener hole 60f can extend through the sixth groove 52f, and the eighth fastener hole 60h can extend through the eighth groove 52h.

A plurality of fasteners 64a, 64b, 64c, 64d, 64e, 64f, 64g and 64h can be engaged through each of the plurality of fastener holes 60a, 60b, 60c, 60d, 60e, 60f, 60g and 60h to secure the plurality of rungs, shown in FIG. 1, to the first support member 12 and the second support member 26. In operation, the plurality of rungs can be rotatable about the plurality of fasteners 64a, 64b, 64c, 64d, 64e, 64f, 64g and 64h to allow the foldable ladder to move between the folded position and the unfolded position.

Each of the plurality of rungs can be secured into the plurality of grooves 52a, 52b, 52c, 52d, 52e, 52f, 52g and 52h by one of the plurality of fasteners 64a, 64b, 64c, 64d, 64e, 64f, 64g and 64h; thereby securing the first support member 12 to the second support member 26.

The first support member 12 can have the first safety extension block 70a secured thereto. The second support member 26 can have the second safety extension block 70b secured thereto. The first and second safety extension blocks 70a and 70b can prevent slipping of the foldable ladder from a surface by providing additional surface area to the foldable ladder for engagement with the surface.

The foldable ladder 10 can have a first nonskid non-deforming elastomeric mat 66a, a second nonskid non-deforming elastomeric mat 66b, a third nonskid non-deforming elastomeric mat 66c, and a fourth nonskid non-deforming elastomeric mat 66d. The nonskid non-deforming elastomeric mats 66a, 66b, 66c and 66d can be disposed over the bottom rounded ends, top rounded ends, and safety extension blocks of the foldable ladder. The nonskid non-deforming elastomeric mats 66a, 66b, 66c and 66d can be made of natural rubber, synthetic rubber, or combinations thereof.

FIG. 3 depicts an embodiment of the foldable ladder in an unfolded configuration. The first safety extension block 70a can be secured to the first support member 12 proximate the first top rounded end, and the second safety extension block 70b can be secured to the second support member 26 proximate the second bottom rounded end. Each of the plurality of rungs 62a, 62b, 62c and 62d can have a flattened top side 80a, 80b, 80c and 80d. When the foldable ladder 10 is in the unfolded position, as depicted, the plurality of rungs 62a, 62b, 62c and 62d can extend perpendicular to the first support member 12 and the second support member 26.

The foldable ladder 10 can include folding struts 84a and 84b on the first support member 12, and folding struts 84c and 84d on the second support member 26. The folding struts 84a, 84b, 84c and 84d can be configured to form tripods for enhanced stability of the foldable ladder 10. The foldable ladder 10 can also have a first handle 88a on the first support member 12 and a second handle 88b on the second support member 26. The handles 88a and 88b can allow a user to carry the foldable ladder 10.

The foldable ladder 10 can have first magnets 42a and 42b and second magnets 43a and 43b, each contained within one of a plurality of non-magnetic housings 68a, 68b, 68c and 68d. The plurality of non-magnetic housings 68a, 68b, 68c and 68d can be disposed in the first outer surface and the second outer surface for containing the first magnets 42a and 42b and the second magnets 43a and 43b. In one or more embodiment, the first magnets 42a and 42b and second magnets 43a and 43b can be secured on the first outer surface and the second outer surface without the plurality of non-magnetic housings.

The foldable ladder 10 can be made of a material configured to allow the first magnets 42a and 42b on the first outer surface and the second magnets 43a and 43b on the second outer surface to attract one another through the first support member 12 and the second support member 26.

FIGS. 4A-4B depict the foldable ladder in the folded position. Each rung, such as the first rung 62a, can be pivotable to move the foldable ladder 10 between the folded position and the unfolded position. When the foldable ladder is in the folded position, each rung can rest at least partially within one of the first plurality of grooves and one of the second plurality of grooves; thereby allowing the first support member 12 to engage the second support member 26. For example, the first rung 62a can rest at least partially within the first groove 52a of the first support member 12, while also resting at least partially within the second groove 52b of the second support member 26.

Also shown in this Figure are the first and second safety extension blocks 70a and 70b.

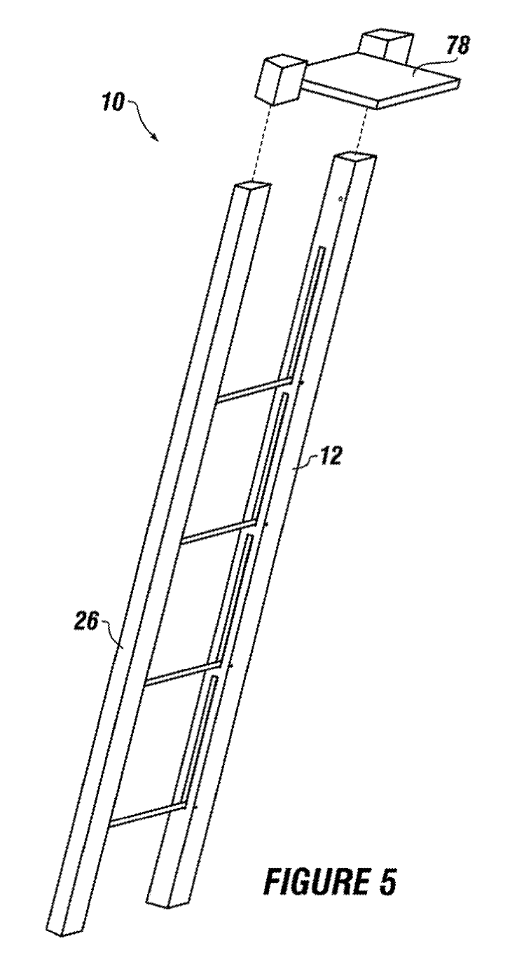

FIG. 5 depicts the foldable ladder 10 having a tray 78, which can be engaged over the first support member 12 and the second support member 26, providing a storage surface.

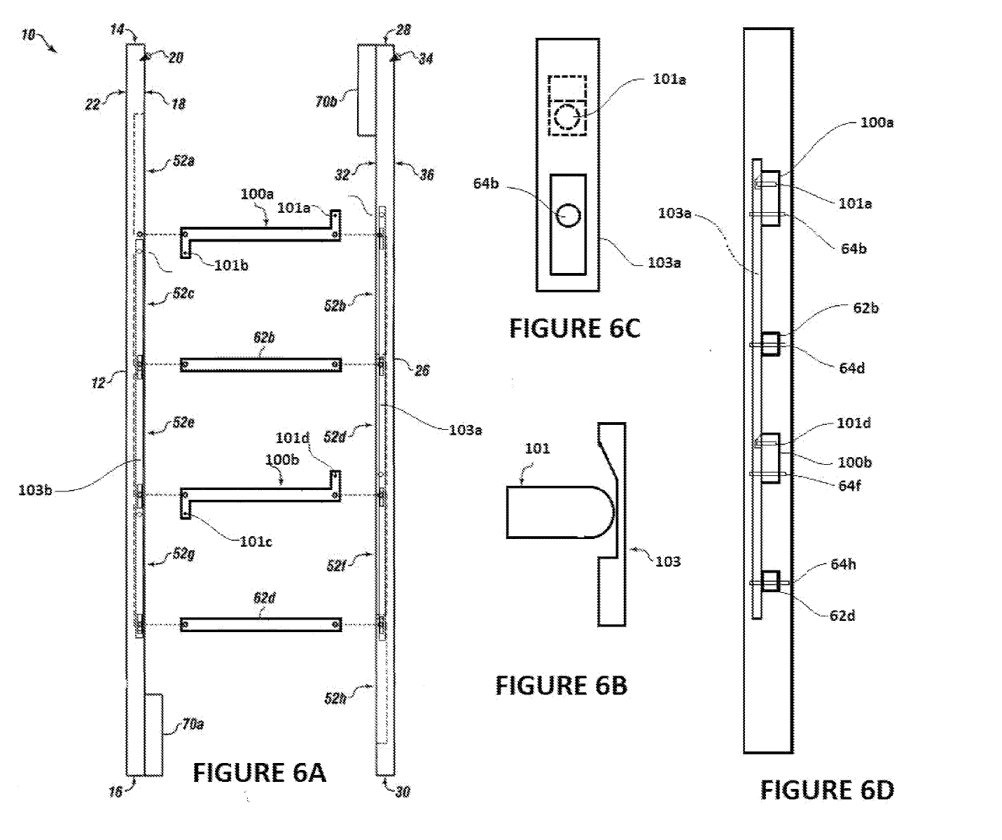

FIG. 6A depicts an exploded view of the foldable ladder 10 showing Z-rungs 100a and 100b according to one or more embodiments. In addition to fastener holes, Z-rung 100a has locking pin holes into which a locking pin 101 can enter. When a locking pin 101 is engaged it will be partly within a rung 100a or 100b and partly within a support member 12 or 26, the locking pin can prevent the Z-rung 100a or 100b from rotating relative to the support member 12 or 26, thereby locking the foldable ladder in the extended position. Also shown are sliding bars 103a and 103b. Sliding bar 103a is slidingly mounted on support member 26 and sliding bar 103b is slidingly mounted on support member 12. A sliding bar can be mounted on a support member so that the sliding bar can slide relative to the support member. One way to achieve the sliding relation between a sliding bar and a support member according to one or more embodiments is to have brackets or a length wise track or groove on the support member and place the sliding bar on the support member's track or in the support member's groove or brackets so that the sliding bar 103 is free to slide length wise back and forth but is otherwise constrained.

FIG. 6B depicts a detailed side view of a portion of the foldable ladder 10 of FIG. 6A showing a locking pin 101 and a sliding bar 103 according to one or more embodiments. As the sliding bar 103 slides length wise its surface engages the end of the spring loaded locking pin 101 to change the locking pin's position moving the locking pin 101 forward or backward. Moving the locking pin forward or backward can change whether the locking pin is within the support member, the rung, or both. When a locking pin is engaged it will simultaneously be within both a support member's locking pin hole and a rung's locking pin hole and the rung and support member will not rotate relative to one another. When the locking pin is disengaged it may be within a rung's locking pin hole or a support member's locking pin hole, but it will not be within both simultaneously. It should be appreciated that while a sliding bar allows one to move a plurality of locking pins simultaneously to an engaged or disengaged position, one or more additional embodiments may achieve the same result without a sliding bar. For example, a folding ladder with only one or two locking pins would not require a means to simultaneously move locking pins because the locking pins could just be moved by hand. A means to simultaneously move locking pins could comprise also comprise a flat member connected to a support member by a hinge on one side and long enough to simultaneously engage a plurality of locking pins when the flat member is pushed.

FIG. 6C depicts a detailed front view of a portion of the foldable ladder 10 of FIG. 6A showing a locking pin 101a, a sliding bar 103a, and a fastener 64b according to one or more embodiments. A rectangular slot cut into the sliding bar 103a allows it to slide past the fastener 64b according to one or more embodiments.

FIG. 6D depicts a side view of the foldable ladder 10 of FIG. 6A according to one or more embodiments. The Z-rung 100A is rotatably connected to the support member 26 by fastener 64b. The rung 62b is rotatably connected to support member 26 by fastener 64d. The Z-rung 100b is rotatably connected to support member 26 by fastener 64f. Rung 62d is rotatably connected to support member 26 by fastener 64h. Sliding bar 103a can move up and down so that its surface can simultaneously move locking pin 101d and locking pin 101a to an engaged or disengaged position.

It should be appreciated that in one or more embodiments in addition to Z-rungs, a straight rung or various other shapes could have a locking pin hole. It should be appreciated that depending on locking pin hole location, a folding ladder 10 could be locked in either a folded or extended position according to one or more embodiments. It should be appreciated that in one or more embodiments, if a rung or support member has a plurality of locking pin holes for a single locking pin the folding ladder could be locked in a plurality of positions.

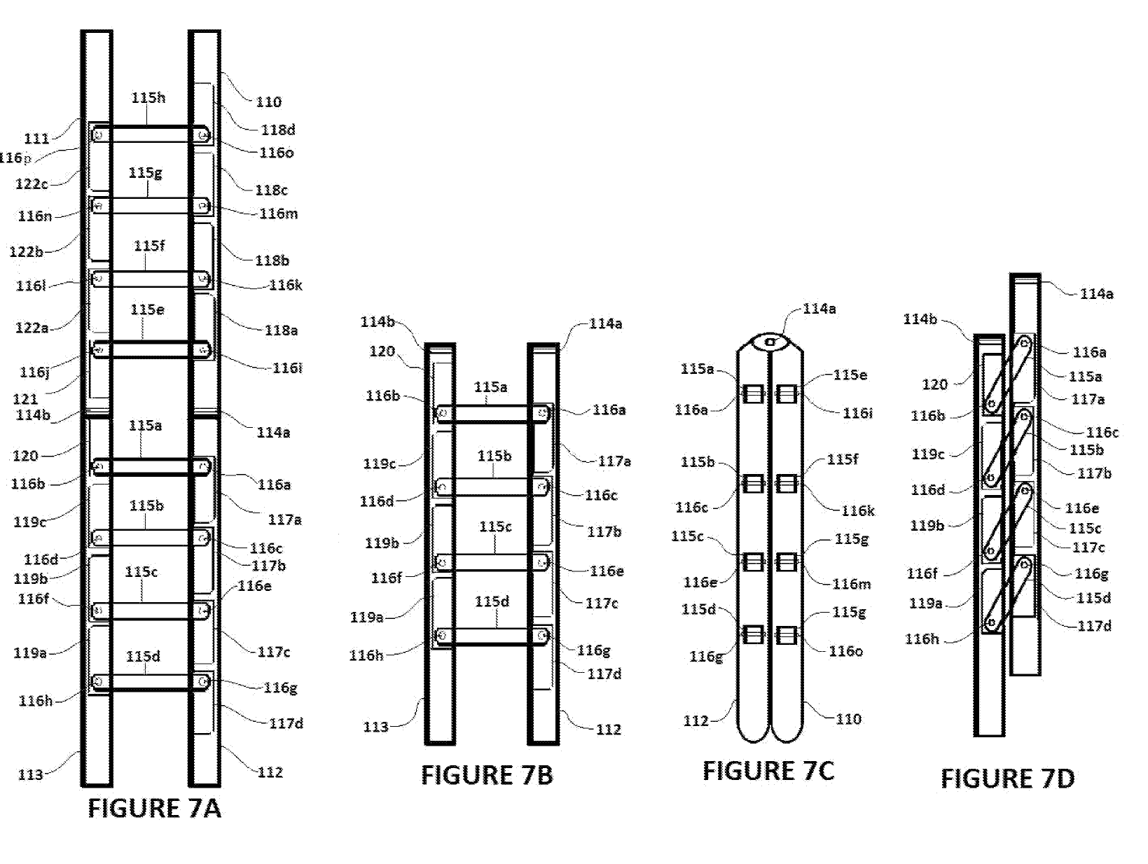

FIG. 7A depicts a front view of a foldable ladder in an extended and straightened position according to one or more embodiments. The folding ladder of FIG. 7a comprises four support members 110, 111, 112, and 113 each having one hinged end, where the hinged end of support member 110 is rotatably connected by a hinge 114a to the hinged end of support member 112 and the hinged end of support member 111 is rotatably connected by a hinge 114b to the hinged end of support member 113. Support member 111 comprises grooves 122c, 122b, 122a, and 121. Support member 110 comprises grooves 118a, 118b 118c, and 118d.

Support member 112 comprises grooves 117a, 117b 117c, and 117d. Support member 113 comprises grooves 119a, 119b 119c, and 120.

Rung 115a is rotatably mounted in groove 117a by fastener 116a and rotatably mounted in groove 120 by fastener 116b. Rung 115b is rotatably mounted in groove 117b by fastener 116c and rotatably mounted in groove 119c by fastener 116d. Rung 115c is rotatably mounted in groove 117c by fastener 116e and rotatably mounted in groove 119b by fastener 116f. Rung 115d is rotatably mounted in groove 117d by fastener 116g and rotatably mounted in groove 119a by fastener 116h. Rung 115e is rotatably mounted in groove 118a by fastener 116i and rotatably mounted in groove 121 by fastener 116j. Rung 115f is rotatably mounted in groove 118b by fastener 116k and rotatably mounted in groove 122a by fastener 116l. Rung 115g is rotatably mounted in groove 118c by fastener 116m and rotatably mounted in groove 122b by fastener 116n. Rung 115h is rotatably mounted in groove 118d by fastener 116o and rotatably mounted in groove 122c by fastener 116p.

FIG. 7B depicts a front view of the foldable ladder of FIG. 7A in an extended and bent over double position according to one or more embodiments. In the bent over double position, support member 112 and support member 113 visible, but support member 111 and support member 110 are not visible since they are directly behind the visible members 112, 113. Rungs 115a, 115b, 115c, and 115d are visible, but rungs 115e, 115f, 115g, and 115h are not visible because they lie directly behind the visible rungs. Likewise fasteners 116a, 116b, 116c, 116d, 116e, 116f, 116g, and 116h are visible but fasteners 116i, 116j, 116k, 116l, 116m, 116n, 116o, and 116p are not visible because they lied directly behind the visible fasteners. In the bent over double position, fastener 116a is coaxial with fastener 116i, fastener 116b is coaxial with fastener 116j, fastener 116c is coaxial with fastener 116k, fastener 116d is coaxial with fastener 116l, fastener 116e is coaxial with fastener 116m, fastener 116f is coaxial with fastener 116n, fastener 116g is coaxial with fastener 116o, and fastener 116h is coaxial with fastener 116p. Hinge 114a is coaxial with hinge 114b.

FIG. 7C depicts a side view of the foldable ladder of FIG. 7A in an extended and bent over double position according to one or more embodiments. Support members 110 and 112 are visible but support members 111 and 113 are not visible since they are directly behind the visible members. Support members 110 and 112 are rotatably connected at their hinged ends by hinge 114a. In the bent over double position, fastener 116a is coaxial with fastener 116i, fastener 116c is coaxial with fastener 116k, fastener 116e is coaxial with fastener 116m, and fastener 116g is coaxial with fastener 116o.

FIG. 7D depicts a front view of the foldable ladder of FIG. 7A in a bent over double and folded position according to one or more embodiments. The same components from FIG. 7B are visible in FIG. 7D, but rungs 115a, 115b, 115c, and 115d are rotated relative to support members 113 and 112 so that rungs 115a, 115b, 115c, and 115d are no longer perpendicular to support members 113 and 112. Support members 113 and 112 are now adjacent to one another and rungs 115a, 115b, 115c, and 115d are located within grooves 119a, 119b, 119c, 120, 117a, 117b, 117c, and 117d. In this position hinge 114a and hinge 114b are no longer coaxial.

In operation, a folding ladder in the bent over double and folded position shown in FIG. 7D can be extended to the extended and bent over double double position shown in FIGS. 7B and 7C by pulling the support members 113 and 111 apart from support members 112 and 110 until the rungs 115 are perpendicular to the support members 110, 111, 112, and 113. Then the folding ladder 10 can be unbent (or straightened) from the bent over double position as shown in FIGS. 7B and 7C to the extended and straightened position shown in FIG. 7A by rotating support members 110 and 111 relative to support members 112 and 113 at hinges 114a and 114b. It should be appreciated that while FIG. 7A shows support members 110 and 111 rotated 180 degrees from the bent over double position relative to support members 112 and 113, if support members 110 and 111 are rotated a smaller angle from the bent over double position relative to support members 112 and 113 the folding ladder 10 could serve as a step ladder.

One or more embodiments of the folding ladder 10 as shown in FIGS. 7A, 7B, 7C, and 7D could comprise means to lock support members 110 and 111 into position at one or more angles as they are rotated from the bent over double position relative to support members 112 and 113. Examples could include one or more locking pins or one or more ratchet mechanisms that act upon some combination of support members 110, 111, 112, and 113 and hinges 114a and 114b.

One or more embodiments of the folding ladder 10 as shown in FIGS. 7A, 7B, 7C, and 7D could comprise means to lock the ladder in the extended position with rungs 115 perpendicular to support members 110, 111, 112, and 113. One example could comprise one or more stops to prevent the rungs 115 from extending past the perpendicular position as the ladder is extended from the folded position shown in FIG. 7D to the extended positions shown in FIGS. 7B and 7C. When the one or more of the grooves in support members provide sufficient clearance for the rungs 115 to rotate to the perpendicular position but no further as the ladder is extended, then the grooves can act as a stop to prevent the ladder from extending beyond the point where the rungs 115 are perpendicular to the support members. When one or more of the rungs connecting support member 112 to support member 113 is constrained from extending past perpendicular and one or more of the rungs connecting support member 110 to support member 111 is constrained from extending past perpendicular, unbending (or straightening) the from the bent over double position as shown in FIGS. 7B and 7C to the extended and straightened position shown in FIG. 7A by rotating support members 110 and 111 relative to support members 112 and 113 at hinges 114a and 114b will also lock the ladder into the extended position with rungs parallel to the support members. To illustrate this feature, consider rungs 115a and 115e as shown in FIG. 7A, where the top of groove 117a and the bottom of groove 120 constrain rung 115a from rotating clockwise about fasteners 116a and 116b while the top of groove 121 and the bottom of groove 118a constrain rung 115e from rotating counterclockwise about fasteners 116i and 116j. Because rungs 115 must rotate the same way to fold the ladder and rungs 115a and 115e are constrained from rotating the same way, the ladder is thereby locked in the extended position while the ladder is straightened. After the ladder is bent all the way to the bent doubled over position shown in FIGS. 7B and 7C, 115a and 115e can both rotate counterclockwise, and the ladder can be folded to the position shown in FIG. 7D. It is not necessary to unbend the ladder all the way from the bent over double position to the straightened position to lock the ladder in the extended position, since unbending the ladder partially (such as for use as a step ladder) will also lock the ladder in the extended position, since the rungs 115 no longer all rotate in the same plane (for example rung 115a no longer rotates in the same plane as rung 115e) and cannot rotate together in the same plane to fold the folding ladder.

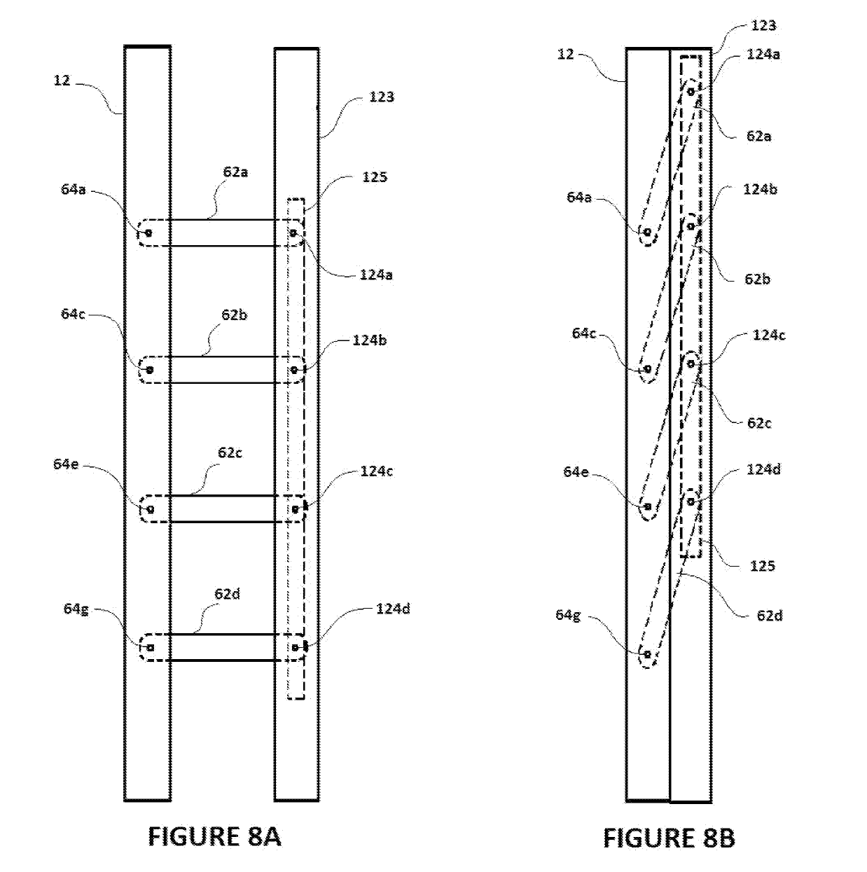

FIG. 8A depicts a foldable ladder in an extended position according to one or more embodiments. Rung 62a is rotatably connected to member 12 by fastener 64a and rotatably connected to sliding bar 125 by fastener 124a. Rung 62b is rotatably connected to member 12 by fastener 64c and rotatably connected to sliding bar 125 by fastener 124b. Rung 62c is rotatably connected to member 12 by fastener 64e and rotatably connected to sliding bar 125 by fastener 124c. Rung 62d is rotatably connected to member 12 by fastener 64g and rotatably connected to sliding bar 125 by fastener 124d. Sliding member 125 is slidingly mounted on support member 123. A sliding member can be mounted on a support member so that the sliding member can slide relative to the support member. One way to achieve the sliding relation between a sliding member 125 and a support member 123 according to one or more embodiments is to have brackets or a length wise track or groove on the support member 123 and place the sliding member 125 on the support member's track or in the support member's groove or brackets so that the sliding member 125 is free to slide length wise up and down along the support member's length but is otherwise constrained. In the extended position, rungs 62a, 62b, 62c, and 62d are perpendicular to support members 12 and 123.

FIG. 8B depicts a foldable ladder in a folded position according to one or more embodiments. In the folded position, the sliding member 125 is moved upward along support member 123 to rotate rungs 62a, 62b, 62c, and 62d counterclockwise and allow support members 12 and 123 to stand side by side next to one another.

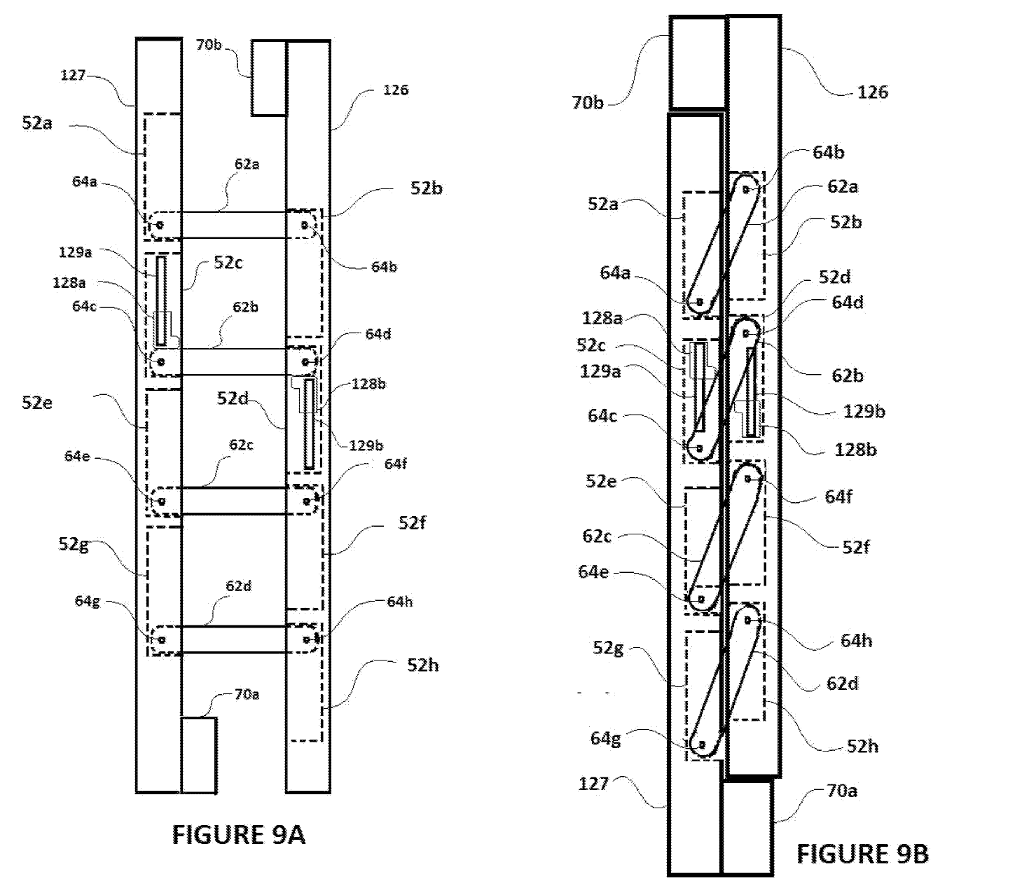

FIG. 9A depicts a foldable ladder in an extended position according to one or more embodiments. The first safety extension block 70a can be secured to the first support member 127 proximate the first top rounded end, and the second safety extension block 70b can be secured to the second support member 126 proximate the second bottom rounded end. When the foldable ladder 10 is in the unfolded position, as depicted, the plurality of rungs 62a, 62b, 62c and 62d can extend perpendicular to the first support member 127 and the second support member 126. Support member 126 comprises grooves 52b, 52d, 52f, and 52h and support member 127 comprises grooves 52a, 52c, 52e, and 52g. One end of rung 62a is rotatably mounted in groove 52a with fastener 64a and the other end of rung 62a is rotatably mounted in groove 52b with fastener 64b. One end of rung 62b is rotatably mounted in groove 52c with fastener 64c and the other end of rung 62b is rotatably mounted in groove 52d with fastener 64d. One end of rung 62c is rotatably mounted in groove 52e with fastener 64e and the other end of rung 62c is rotatably mounted in groove 52f with fastener 64f. One end of rung 62d is rotatably mounted in groove 52g with fastener 64g and the other end of rung 62d is rotatably mounted in groove 52h with fastener 64h. Locking block track 129a is mounted within groove 52c along the groove's length and locking block 128a is slidingly mounted on locking block track 129a so that it can move along the tracks length within the groove but is otherwise constrained. Locking block 128a will preferably comprise a means for locking it in one or more positions along locking block track 129a so that when the folding ladder is in the extended position as shown, the locking block 128a can be slid down locking block track 129a to contact rung 62b and lock into that position to constrain rung 62b from rotating counterclockwise, thus locking the folding ladder in the extended position. Locking block track 129b is mounted within groove 52d along the groove's length and locking block 128b is slidingly mounted on locking block track 129b so that it can move along the tracks length within the groove but is otherwise constrained. Locking block 128b will preferably comprise a means for locking it in one or more positions along locking block track 129b so that when the folding ladder is in the extended position as shown, the locking block 128b can be slid up locking block track 129b to contact rung 62b and lock into that position to constrain rung 62b from rotating counterclockwise, thus locking the folding ladder in the extended position. FIG. 9B depicts a foldable ladder in a folded position according to one or more embodiments. In operation, after the locking blocks 128a and 128b are unlocked and allowed to slide along their locking block tracks 129a and 129b away from rung 62b, the rung 62b can rotate counterclockwise allowing the folding ladder to move to the folded position as shown.

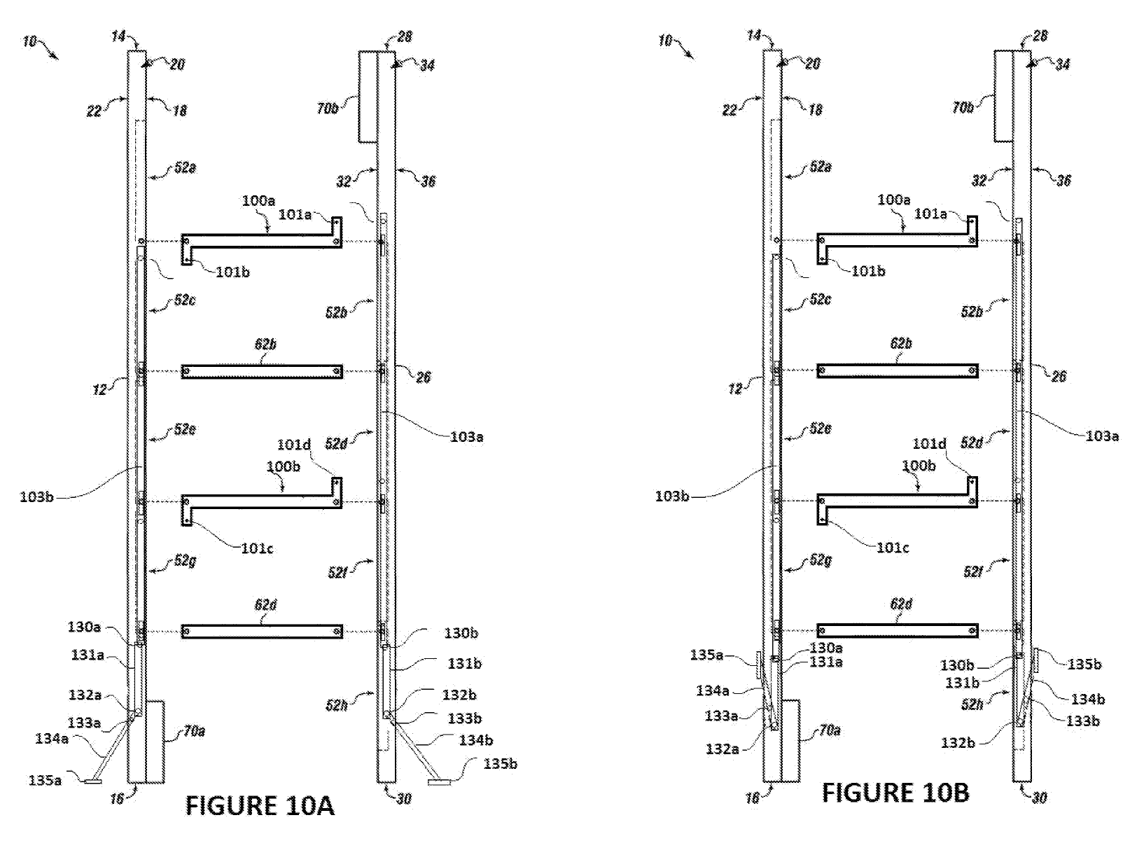

FIG. 10A depicts an exploded view of a foldable ladder with foot lever actuated locking bars in the locked extended position according to one or more embodiments. In addition to fastener holes, Z-rung 100a has locking pin holes into which a locking pins 101a and 101b can enter. When a locking pin 101 is engaged it will be partly within a rung 100a or 100b and partly within a support member 12 or 26, the locking pin can prevent the Z-rung 100a or 100b from rotating relative to the support member 12 or 26, thereby locking the foldable ladder in the extended position. Support member 12 comprises a top end 14 and a bottom end 16. Also shown are sliding bars 103a and 103b. Sliding bar 103a is slidingly mounted on support member 26 and sliding bar 103b is slidingly mounted on support member 12. A sliding bar can be mounted on a support member so that the sliding bar can slide relative to the support member. One way to achieve the sliding relation between a sliding bar and a support member according to one or more embodiments is to have brackets or a length wise track or groove on the support member and place the sliding bar on the support member's track or in the support member's groove or brackets so that the sliding bar 103 is free to slide length wise back and forth but is otherwise constrained.

A hinge 130a connects linkage 131a to locking bar 103b. Linkage 131a rotatably connects rod from foot lever 134 to locking bar 103b. A hinge joint 132a rotatably connects foot lever 134a to linkage 131a. A hinge joint 133 rotatably connects foot lever 134 to support member 12. Foot lever 134a used to push locking bar 103b into locked position and when locked out acts to stabilize folding ladder 10. Foot lever 134a comprises a foot pad 135a for traction on floors or the ground. A hinge 130b connects linkage 131b to locking bar 103a. Linkage 131b connects foot lever 134b to locking bar 103a. A hinge joint 132b rotatably connects foot lever 134b to linkage 131b. A hinge joint 133b rotatably connects foot lever 134b to support member 26. Foot lever 134b is used to push locking bar 103a into the locked position and when locked out acts to stabilize folding ladder 10. Foot lever 134b comprises a foot pad 135b for traction on floors or the ground. FIG. 10B depicts an exploded view of a foldable ladder with foot lever 134a and 134b actuated locking bars 103a and 103b in the unlocked position according to one or more embodiments.

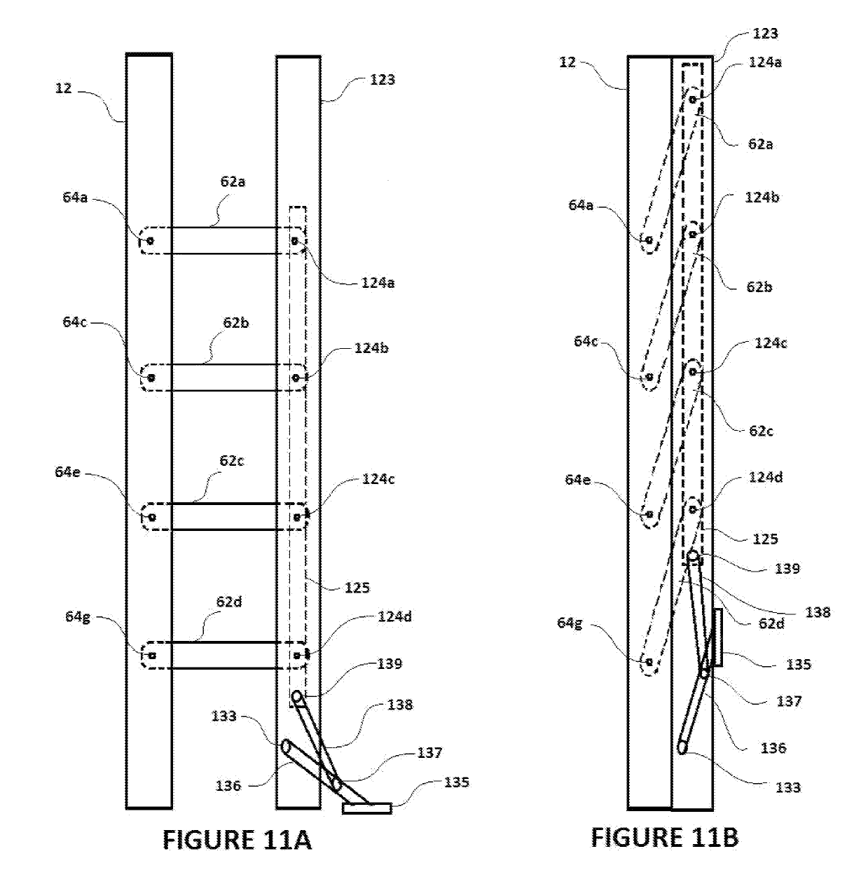

FIG. 11A depicts a view of a foldable ladder 10 with foot lever actuated locking bar in the locked extended position according to one or more embodiments. FIG. 11B depicts a view of a foldable ladder in the folded position with a foot lever actuated locking bar in the unlocked position according to one or more embodiments. Pin joint 137 connects foot lever 136 to linkage 138. Linkage 138 connects foot lever 136 to sliding bar 125. Pin joint 139 connects linkage 138 to sliding bar 125. Sliding bar 125 is slidingly connected to support member 123 and rotatably connected to one end of rungs 62a, 62b, 62c, and 62d by pins 124a, 124b, 124c, and 124d. The other end of rungs 62a, 62b, 62c, and 62d are rotatably connected to support member 12 by pins 64a, 64c, 64e, and 64g. In operation, moving folded ladder's foot lever 136 from the unlocked position shown in FIG. 11B to the down to the floor will cause linkage 138 to pull sliding bar 125 downward along support member 123 causing rungs 62a, 62b, 62c, and 62d to rotate clockwise to the perpendicular position as support members 12 and 123 move apart as shown in FIG. 11A. One or more embodiments could comprise means, such as a locking pin that passes through the sliding bar 125 and the support member 123, for locking the folding ladder in the extended position.

While these embodiments have been described with emphasis on the embodiments, it should be understood that within the scope of the appended claims, the embodiments might be practiced other than as specifically described herein.

What is claimed is:

1. A lightweight foldable ladder moveable between a folded position and an unfolded position, the lightweight foldable ladder comprising:
a first support member comprising a first top rounded end, a first bottom rounded end, a first front surface, a first back surface, a first inner surface, and a first outer surface;
a second support member comprising a second top rounded end, a second bottom rounded end, a second front surface, a second back surface, a second inner surface, and a second outer surface;
a first plurality of grooves disposed in the first inner surface and a second plurality of grooves disposed in the second inner surface, wherein each groove comprises:
(i) a groove bottom end; and
(ii) a groove top end, wherein when the lightweight foldable ladder is in the folded position: a portion of each groove proximate the groove top end of the first plurality of grooves is aligned with a portion of one of the groove bottom ends of the second plurality of grooves;
a plurality of moveable rungs, wherein each moveable rung is secured at a first end within the groove top end of one of the first plurality of grooves and at a second end within the groove bottom end one of the second plurality of grooves to secure the first support member to the second support member, wherein each moveable rung is pivotable to move the lightweight foldable ladder between the folded position and the unfolded position, and wherein:
when the lightweight foldable ladder is in the unfolded position the plurality of moveable rungs extend perpendicular to the first support member and the second support member; and
when the lightweight foldable ladder is in the folded position each moveable rung rests at least partially within one of the first plurality of grooves and within one of the second plurality of grooves, allowing the first support member to engage the second support member;
at least one first magnet disposed in or on the first support member; and
at least one second magnet disposed in or on the second support member, wherein the at least one first magnet forms at least one magnet pair with the at least one second magnet, and wherein:
(i) when the lightweight foldable ladder is in the unfolded position the at least one first magnet is magnetically disengaged from the at least one second magnet; and
(ii) when the lightweight foldable ladder is in the folded position the at least one first magnet is magnetically engaged with the at least one second magnet to secure the first support member to the second support member.

2. The lightweight foldable ladder of claim 1, further comprising:
a. a first plurality of fastener holes disposed through the first support member from the first front surface to the first back surface;
b. a second plurality of fastener holes disposed through the second support member from the second front surface to the second back surface; and
c. a plurality of fasteners engaged through each of the first plurality of fastener holes and the second plurality of fastener holes to secure the plurality of moveable rungs to the first support member and the second support member, wherein the plurality of moveable rungs are rotatable about the plurality of fasteners to allow the lightweight foldable ladder to move between the folded position and the unfolded position.

3. The lightweight foldable ladder of claim 1, further comprising a plurality nonskid nondeforming elastomeric mats engaged on the first top rounded end, the first bottom rounded end, the second top rounded end, and the second bottom rounded end.

4. The lightweight foldable ladder of claim 3, wherein the nonskid non-deforming elastomeric mats comprise natural rubber, synthetic rubber, or combinations thereof.

5. The lightweight foldable ladder of claim 1, wherein the lightweight foldable ladder comprises aluminum, another metal, composite polymer, metal alloy, or polymer coated metal.

6. The lightweight foldable ladder of claim 1, wherein the plurality of moveable rungs are hollow metal rungs.

7. The lightweight foldable ladder of claim 1, wherein:
the at least one first magnet is in or on the first inner surface, and the at least one second magnet is in or on the second inner surface; or
the at least one first magnet is in or on the first outer surface, and the at least one second magnet is in or on the second outer surface.

8. The lightweight foldable ladder of claim 1, further comprising at least one first nonmagnetic housing disposed in or on the first support member for containing the at least one first magnet, and at least one second non-magnetic housing disposed in or on the second support member for containing the at least one second magnet.

9. The lightweight foldable ladder of claim 1, further comprising a tray engaged with the first support member and the second support member.

10. The lightweight foldable ladder of claim 1, further comprising a first wheel pivotably connected proximate the first bottom rounded end and a second wheel pivotably connected proximate the second bottom rounded end, wherein the wheels are pivotable between a transport position and a storage position, and wherein when the wheels are in the transport position the wheels support the lightweight foldable ladder for ease of transport.

12. The lightweight foldable ladder of claim 1, wherein the first support member has a first safety extension block secured to the first top rounded end or the first bottom rounded end, and the second support member has a second safety extension block secured to the second top rounded end or the second bottom rounded end.

13. A foldable ladder moveable between a folded position and an unfolded position, the foldable ladder comprising:
a. a first support member comprising a first inner surface;
b. a second support member comprising a second inner surface;
c. a first plurality of grooves disposed in the first inner surface;
d. a second plurality of grooves disposed in the second inner surface, wherein when the foldable ladder is in the folded position: a portion of each groove of the first plurality of grooves is aligned with a portion of at least one of the grooves of the second plurality of grooves; and
e. a plurality of rungs, wherein each rung is secured at a first end within one of the first plurality of grooves and at a second end within one of the second plurality of grooves to secure the first support member to the second support member, wherein each rung is pivotable to move the foldable ladder between the folded position and the unfolded position, and wherein:
(i) when the foldable ladder is in the unfolded position the plurality of rungs extend perpendicular to the first support member and the second support member; and
(ii) when the foldable ladder is in the folded position each rung rests at least partially within one of the first plurality of grooves and within one of the second plurality of grooves, allowing the first support member to engage the second support member.

14. The foldable ladder of claim 13, further comprising a first magnet disposed on the first support member and a second magnet disposed on the second support member, wherein the first magnet and the second magnet form a first magnet pair, and wherein:
a. when the foldable ladder is in the unfolded position the first magnet is disengaged from the second magnet; and
b. when the foldable ladder is in the folded position the first magnet is magnetically engaged with the second magnet to secure the first support member to the second support member.

15. The foldable ladder of claim 13, wherein:
a. the first magnet is in or on the first inner surface, and the second magnet is in or on the second inner surface; or
b. the first magnet is in or on a first outer surface of the first support member, and the second magnet is in or on a second outer surface of the second support member.

16. The foldable ladder of claim 13, further comprising a first plurality of magnets disposed on the first support member and a second plurality of magnets disposed on the second support member, wherein each of the first plurality of magnets forms a magnet pair with one of the second plurality of magnets, and wherein:
a. when the foldable ladder is in the unfolded position each magnet pair is in a disengaged configuration; and
b. when the foldable ladder is in the folded position each magnet pair is in a magnetically engaged configuration to secure the first support member to the second support member.

17. The foldable ladder of claim 13, wherein the first support member has a first safety extension block secured thereto, and the second support member has a second safety extension block secured thereto.

18. The foldable ladder of claim 17, further comprising a plurality nonskid non-deforming elastomeric mats engaged on the first support member, the first safety extension block, the second support member, and the second safety extension block.

19. A lightweight foldable ladder moveable between a folded position and an unfolded position, the lightweight foldable ladder comprising:
a first support member comprising a first top hinged end, a first bottom rounded end, a first front surface, a first back surface, a first inner surface, and a first outer surface;
a second support member comprising a second top hinged end, a second bottom rounded end, a second front surface, a second back surface, a second inner surface, and a second outer surface;
a third support member comprising a third top hinged end, a third bottom rounded end, a third front surface, a third back surface, a third inner surface, and a third outer surface;
a fourth support member comprising a fourth top hinged end, a fourth bottom rounded end, a fourth front surface, a fourth back surface, a fourth inner surface, and a fourth outer surface;
wherein, said first support member's top hinged end is rotatably connected to said third support member's top hinged end and
said second support member's top hinged end is rotatably connected to said fourth support member's top hinged end
a first plurality of grooves disposed in the first inner surface, a second plurality of grooves disposed in the second inner surface, a third plurality of grooves disposed in the third inner surface, and a fourth plurality of grooves disposed in the fourth inner surface wherein each groove comprises:
(i) a groove bottom end; and
(ii) a groove top end, wherein when the lightweight foldable ladder is in the folded position: a portion of each groove proximate the groove top end of the first plurality of grooves is aligned with a portion of one of the groove bottom ends of the second plurality of grooves;
a plurality of moveable rungs, wherein one or more moveable rung is secured at a first end within the groove top end of one of the first plurality of grooves and at a second end within the groove bottom end one of the second plurality of grooves to secure the first support member to the second support member; and
one or more moveable rung is secured at a first end within the groove top end of one of the third plurality of grooves and at a
second end within the groove bottom end one of the fourth plurality of grooves to secure the first support member to the second support member
wherein each moveable rung is pivotable to move the lightweight foldable ladder between the folded position and the unfolded position when the support members are bent to a bent over double position, and wherein:
when the lightweight foldable ladder is in the unfolded position the plurality of moveable rungs extend perpendicular to the first support member and the second support member and to the third support member and the fourth support member and the support members can be unbent from bent over double position to a straightened position; and
when the lightweight foldable ladder is in the bent over double and folded position each moveable rung rests at least partially within either one of the first plurality of grooves and within one of the second plurality of grooves or within one of the third plurality of grooves and within one of the fourth plurality of grooves, allowing
the first support member to engage the second support member and the third support member to engage the fourth support member.
